(19) United States
(12) Patent Application Publication
(10) Pub. No.: US 2015/0378523 A1
(43) Pub. Date: Dec. 31, 2015

(54) METHOD AND SERVER FOR EXECUTING ONLINE GAME

(71) Applicants: Jae Ho Won, Seoul (KR); Young Jae Park, Seoul (KR)

(72) Inventors: Jae Ho Won, Seoul (KR); Young Jae Park, Seoul (KR)

(73) Assignee: INTELLECTUAL DISCOVERY CO., LTD., Seoul (KR)

(21) Appl. No.: 14/369,882

(22) PCT Filed: Jun. 5, 2012
(86) PCT No.: PCT/KR2012/004415

§ 371 Date: Aug. 5, 2015

(30) Foreign Application Priority Data
Dec. 29, 2011 (KR) 10-2011-0146334

(51) Int. Cl. G06F 3/0482; A63F 13/30

(52) U.S. Cl. CPC G06F 3/0482; A63F 13/30

(57) ABSTRACT

The present invention relates to a technology for rapidly executing game play by decreasing the number of pages that need to be loaded by omitting some of one or more predetermined operations which need to be preceded in order to start the game play. A method of executing an online game includes: transmitting, by a server for executing the online game, an inputtable quick start menu item, which omits some of one or more predetermined operations which need to be preceded in order to start game play, and maintains one or more game elements correctable by the predetermined operations to be in a state prior to the start of the play to start the game play, to a user terminal; determining whether at least one omission condition that is a condition under which some operations among the predetermined operations are omitted, is satisfied when receiving a selection-input for the quick start menu item from the user terminal; and controlling the game play to be started when all of the omission conditions are satisfied.

### TECHNICAL FIELD

The present invention relates to a method and a server for executing an online game, which decrease the number of pages that need to be loaded by omitting some of one or more predetermined operations which need to be preceded in order to start game play, thereby rapidly executing the game play.

### BACKGROUND ART

According to development of an online network service together with recent developments in graphics technology, the number of users using game contents has rapidly increased. Various types of game contents have been provided so that users may get vicarious satisfaction by controlling characters substituted for the users in a virtual world or controlling various objects existing in the real world.

For example, the game contents enable the users to generate characters substituted for the users in a fantasy world, and to increase levels of the characters so that the generated characters perform various acts, so that the user may relieve stress received from the real world in the virtual world and feel interest.

Otherwise, in a sport game and the like, a user may play a role of a coach, a player, and an owner of a club in a soccer game by operating characters implementing soccer players existing in a real world, so that the user may get vicarious satisfaction, thereby feeling interest.

In order to execute the game, there are pieces of information which need to be set before a game is played by accessing a game server by a user, but most of the information is skipped as it is, which causes inconvenience to users who desire to rapidly play the game.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a method and a server for executing an online game, which rapidly execute the game by decreasing the number of pages that need to be loaded by omitting some of one or more predetermined operations which need to be preceded in order to start game play, thereby increasing satisfaction of a user.

### Technical Solution

An exemplary embodiment of the present invention provides a method of executing an online game, including: transmitting, by a server for executing the online game, an inputtable quick start menu item, which omits some of one or more predetermined operations which need to be preceded in order to start game play, and maintains one or more game elements correctable by the predetermined operations to be in a state prior to the start of the play to start the game play, to a user terminal; determining whether at least one omission condition that is a condition under which some operations among the predetermined operations are omitted, is satisfied when receiving a selection-input for the quick start menu item from the user terminal; and controlling the game play to be started when all of the omission conditions are satisfied.

The one or more predetermined operations which need to be preceded may include replacing one or more characters played in the game or changing states of the one or more characters as an operation of setting the one or more game elements.

The state of the character may be at least one of a state of a condition element which is an element for changing an applied ability value according to a predetermined ratio and applying the changed ability value, and a state of a physical strength element which is an element consumed during the game play and decreasing the applied ability value according to the consumption, when being used during the game play.

The determining whether the omission condition is satisfied may include determining that the omission condition is satisfied when a physical strength element which is an element consumed during the game play and decreasing the applied ability value according to the consumption is equal to or greater than a predetermined numerical value, a use period of the character is equal to or greater than a predetermined period, and the character is applied to the game play and is in a usable state.

The transmitting of the quick start menu item may include outputting an automatic item use menu item as an inputtable menu item for determining whether to use at least one of an item for increasing a condition element which is an element for changing an ability value of the character according to a predetermined ratio and applying the changed ability value during the game play, and an item for increasing a physical strength element which is an element consumed during the game play and decreasing the applied ability value according to the consumption, on a part of the region on which the quick start menu item is displayed.

The method may further include, when the automatic item use menu item is activated, correcting an element between the condition element and the physical strength element, in which a use of a corresponding item is activated, to have a predetermined upper limit when the quick start menu item is selected and input by the user terminal.

The determining whether the omission condition is satisfied may include, in the case where a use of an item corresponding to the physical strength element is activated in the automatic item use menu item, determining that the omission condition is satisfied when a use period of the character is equal to or greater than a predetermined period, and the character is applied to the game play and is in a usable state.

The method may further include, after the determining whether the omission condition is satisfied, when it is determined that there are one or more unsatisfied omission conditions among the omission conditions, transmitting a quick start assistant menu item for correcting one or more game elements corresponding to the unsatisfied omission conditions to the user terminal.

The controlling of the game play to be started may include, according to an input from the user terminal for the quick start assistant menu item, when it is determined that one or more game elements corresponding to the unsatisfied omission conditions are corrected so that all of the unsatisfied omission conditions are solved, controlling the game play to be started.

Another exemplary embodiment of the present invention provides a server for executing an online game, including: transmitting, by a server for executing the online game, an inputtable quick start menu item, which omits some of one or more predetermined operations which need to be preceded in order to start game play, and maintains one or more game elements correctable by the predetermined operations to be in a state prior to the start of the play to start the game play, to a user terminal; determining whether at least one omission condition that is a condition under which some operations among the predetermined operations are omitted, is satisfied when receiving a selection-input for the quick start menu item from the user terminal, and controlling the game play to be started when all of the omission conditions are satisfied; when it is determined that there are one or more unsatisfied omission conditions among the omission conditions, transmitting a quick start assistant menu item for correcting one or more game elements corresponding to the unsatisfied omission conditions to the user terminal; and according to an input from the user terminal for the quick start assistant menu item, when it is determined that one or more game elements corresponding to the unsatisfied omission conditions are corrected so that all of the unsatisfied omission conditions are solved, controlling the game play to be started.

The one or more predetermined operations which need to be preceded may include replacing one or more characters played in the game or changing states of the one or more characters as an operation of setting the one or more game elements.

The state of the character may be at least one of a state of a condition element which is an element for changing an applied ability value according to a predetermined ratio and applying the changed ability value, and a state of a physical strength element which is an element consumed during the game play and decreasing the applied ability value according to the consumption, when being used during the game play.

The determining whether the omission condition is satisfied may include determining that the omission condition is satisfied when a physical strength element which is an element consumed during the game play and decreasing the applied ability value according to the consumption is equal to or greater than a predetermined numerical value, a use period of the character is equal to or greater than a predetermined period, and the character is applied to the game play and is in a usable state.

The transmitting of the quick start menu item may include outputting an automatic item use menu item as an inputtable menu item for determining whether to use at least one of an item for increasing a condition element which is an element for changing an ability value of the character according to a predetermined ratio and applying the changed ability value during the game play, and an item for increasing a physical strength element which is an element consumed during the game play and decreasing the applied ability value according to the consumption, on a part of the region on which the quick start menu item is displayed.

The method may further include, when the automatic item use menu item is activated, correcting an element between the condition element and the physical strength element, in which a use of a corresponding item is activated, to have a predetermined upper limit when the quick start menu item is selected and input by the user terminal.

The determining whether the omission condition is satisfied may include, in the case where a use of an item corresponding to the physical strength element is activated in the automatic item use menu item, determining that the omission condition is satisfied when a use period of the character is equal to or greater than a predetermined period, and the character is applied to the game play and is in a usable state.

Still another exemplary embodiment of the present invention provides a server for executing an online game, including: a transmission unit configured to transmit an inputtable quick start menu item, which omits some of one or more predetermined operations which need to be preceded in order to start game play, and maintains one or more game elements correctable by the predetermined operations to be in a state prior to the start of the play to start the game play, to a user terminal; a determination unit configured to determine whether at least one omission condition that is a condition under which some operations among the predetermined operations are omitted, is satisfied when receiving a selection-input for the quick start menu item from the user terminal; and a controller configured to control the game play to be started when all of the omission conditions are satisfied as a result of the determination of the determination unit.

The determination unit may determine that the omission condition is satisfied when a physical strength element which is an element consumed during the game play and decreasing the applied ability value according to the consumption is equal to or greater than a predetermined numerical value, the use period of the character is equal to or greater than a predetermined period, and the character is applied to the game play and is in a usable state.

The transmission unit may output an automatic item use menu item as an inputtable menu item for determining whether to use at least one of an item for increasing a condition element which is an element for changing an ability value of the character according to a predetermined ratio and applying the changed ability value during the game play, and an item for increasing a physical strength element which is an element consumed during the game play and decreasing the applied ability value according to the consumption, on a part of the region on which the quick start menu item is displayed.

When the automatic item use menu item is activated, the transmission unit may correct an element between the condition element and the physical strength element, in which a use of a corresponding item is activated, to have a predetermined upper limit when the quick start menu item is selected and input by the user terminal.

In the case where a use of an item corresponding to the physical strength element is activated in the automatic item use menu item, the determination unit may determine that the omission condition is satisfied when a use period of the character is equal to or greater than a predetermined period, and the character is applied to the game play and is in a usable state.

When it is determined that there are one or more unsatisfied omission conditions among the omission conditions, the transmission unit may transmit a quick start assistant menu item for correcting one or more game elements corresponding to the unsatisfied omission conditions to the user terminal.

According to an input from the user terminal for the quick start assistant menu item, when it is determined that one or more game elements corresponding to the unsatisfied omission conditions are corrected so that all of the unsatisfied omission conditions are solved, the controller may control the game play to be started.

Yet another exemplary embodiment of the present invention provides a computer readable recording medium recording a program for implementing a method of executing an online game, the method including: transmitting, by a server for executing the online game, an inputtable quick start menu item, which omits some of one or more predetermined operations which need to be preceded in order to start game play, and maintains one or more game elements correctable by the predetermined operations to be in a state prior to the start of the play to start the game play, to a user terminal; determining whether at least one omission condition that is a condition under which some operations among the predetermined operations are omitted, is satisfied when receiving a selection-input for the quick start menu item from the user terminal; and controlling the game play to be started when all of the omission conditions are satisfied.

Still yet another exemplary embodiment of the present invention provides a computer readable recording medium recording a program for implementing a method of executing an online game, the method including: transmitting, by a server for executing the online game, an inputtable quick start menu item, which omits some of one or more predetermined operations which need to be preceded in order to start game play, and maintains one or more game elements correctable by the predetermined operations to be in a state prior to the start of the play to start the game play, to a user terminal; determining whether at least one omission condition that is a condition under which some operations among the predetermined operations are omitted, is satisfied when receiving a selection-input for the quick start menu item from the user terminal, and controlling the game play to be started when all of the omission conditions are satisfied; when it is determined that there are one or more unsatisfied omission conditions among the omission conditions, transmitting a quick start assistant menu item for correcting one or more game elements corresponding to the unsatisfied omission conditions to the user terminal; and according to an input from the user terminal for the quick start assistant menu item, when it is determined that one or more game elements corresponding to the unsatisfied omission conditions are corrected so that all of the unsatisfied omission conditions are solved, controlling the game play to be started.

### Advantageous Effects

According to the exemplary embodiments of the present invention, it is possible to rapidly execute a game by decreasing the number of pages that need to be loaded by omitting some of one or more predetermined operations which need to be preceded in order to start the game play, thereby improving satisfaction of a user.

### DESCRIPTION OF THE DRAWINGS

FIG. 1 is a flowchart illustrating a method of executing an online game according to an exemplary embodiment of the present invention.

FIG. 2 is a flowchart illustrating a method of using an automatic item use menu item according to an exemplary embodiment of the present invention.

FIG. 3 is a flowchart illustrating a method of determining whether an omission condition is satisfied according to an exemplary embodiment of the present invention.

FIG. 4 is a flowchart illustrating a method of using a quick start assistant menu item according to an exemplary embodiment of the present invention.

FIG. 5 is a flowchart illustrating a method of executing an online game according to another exemplary embodiment of the present invention.

FIG. 6 is a block diagram illustrating a configuration of a server for executing an online game according to an exemplary embodiment of the present invention.

FIGS. 7 to 10 are diagrams illustrating examples of game images applied according to the respective exemplary embodiments of the present invention.

### MODE FOR INVENTION

Hereinafter, a method and a server for executing an online game according to each exemplary embodiment of the present invention will be described with reference to the accompanying drawings.

For accurate understanding of the present invention, a description of a publicly known technology for a characteristic of the present invention will be omitted in the description below. The exemplary embodiments below are detailed descriptions for helping the understanding of the present invention, and do not limit the scope of the present invention as a matter of course. Accordingly, an equivalent invention performing the same function as that of the present invention also belongs to the scope of the present invention.

In the description below, the same reference numeral denotes the same element, and unnecessary and overlapping descriptions and a description of a publicly known technology will be omitted.

In an exemplary embodiment of the present invention, “communication”, a “communication network”, and a “network” may be used with the same meaning. Those three terms mean wired/wireless short-range and broadband data transception networks, which may transceive a file between a user terminal, terminals of other users, and a download server.

In the description below, a “game server” means a server computer accessed by users in order to use game contents. In the case where a game has a small capacity or the small number of users, a plurality of game programs may be operated in one game server. Further, in the case where a game has a very large capacity or a large number of real-time accessing users, one or more game servers for operating one game depending on a function of the game may exist.

Further, middleware for a database or servers performing payment processing may be connected to the game server, but descriptions thereof will be omitted in the present invention.

In the present invention, an online game means game contents which users may use by accessing the aforementioned game server. Particularly, the online game means a game which many users enjoy by accessing the game server at the same time, in which a user progresses the game and increases a level through an action of obtaining an experience value while fostering a character and the like. Further, the online game means a game in which a user may buy various kinds of items in order to more smoothly progress the game.

Here, the item means all of pieces of data which may be helpful to progress the game, and is understandable when it is generally called an item in a game. For example, in a role-playing game, an item enabling a user to obtain more experience values when a character substituting the user suppresses a monster, an item capable of changing an appearance of a character, and the like may correspond to the item in the present invention. Further, a mounted item, which may enable a user to easily play a game through an ability value that is improved during a play of the game by registering a specific slot by a character may also be included as the item.

Further, all of the items, such as a card item capable of using a character, an item increasing an ability value of a character for a predetermined time, an item recovering a condition of a character, and an item with which a character is equipped to improve an ability value in a game and change an appearance in a sport game, which a character uses during the progress of a game or a user uses on a web and reflects the used item to a game on the game as mentioned above, may belong to the item in the present invention.

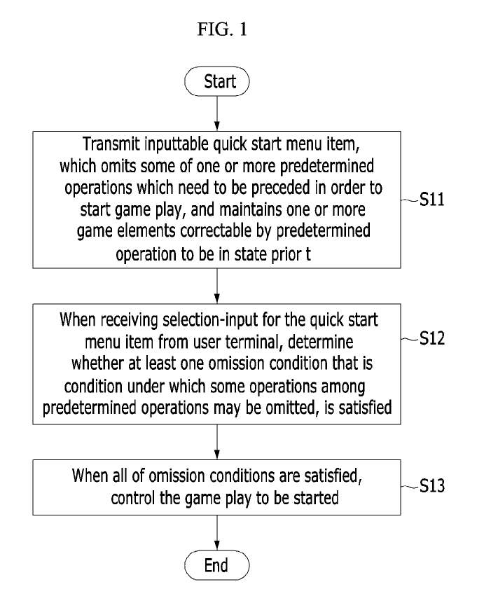

FIG. 1 is a flowchart illustrating a method of executing an online game according to an exemplary embodiment of the present invention.

Referring to FIG. 1, in a method of executing an online game according to an exemplary embodiment of the present invention, a server for executing a game performs an operation of transmitting an inputtable quick start menu item, which omits some of one or more predetermined operations which need to be preceded in order to start game play, and maintains one or more game elements correctable by the predetermined operations to be in a state prior to the start of the play to a user terminal, to start the game play (S11).

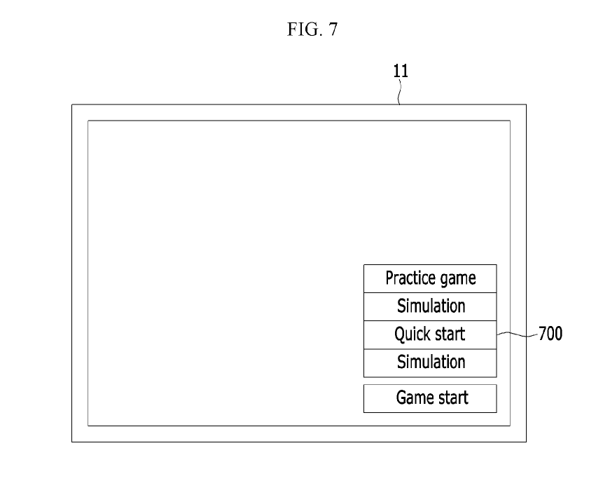

The quick start menu item in the present invention is displayed together with a game start menu item on a screen 11 of the user terminal as illustrated in FIG. 7. When the user selects the game start menu item by using an input means, such as a mouse, a practice game menu item, a simulation menu item, a game start menu item, and the quick start menu item 700 (see FIG. 7) linked with the game start menu item are displayed.

In the present invention, the game play means a unit game based on which the user may play the game on the game. For example, in the case of a sport game, the game play means an event of each sport game.

In the present invention, one or more predetermined operations that need to be preceded are operations of setting one or more game environment elements related to the game play, and the game environment element means an element controlling a value to which an ability value or an additional effect of an item registered in the game play is applied. For example, an ability value of a user character, which is to be improved through equipment of an item, may be changed depending on a game environment element. The game environment element may be differently set for each item.

For example, in the case of a sport game, a registered item may be a player character. In this case, the game environment element may include at least one of a condition element and a physical strength element of a player character.

The condition element means an element capable of changing an applied ability value when an ability value of a player character is used in the game play. In this case, the ability value applied according to the condition may be changed according to a predetermined ratio. The condition element may be divided into a predetermined number, such as “high, medium-high-, medium, medium-low, and low”. When the condition element is high, an applied ability value may be increased to be larger than an ability value of a player character by a predetermined ratio to be applied during the game play, and when the condition element is low, an applied ability value may be decreased to be smaller than an ability value of a player character by a predetermined ratio to be applied during the game play.

The physical strength element is an element consumed according to the game play, and when the physical strength element is consumed, an applied ability value is decreased. For example, compared to the case where the physical strength element is 100, an applied ability value may be decreased by a predetermined ratio in the case where the physical strength element is 70 to be applied in the game play. The physical strength element may be decreased in real time during the game play, and is decreased during the game play based on a physical strength element just before the game play.

Accordingly, the condition element and the physical strength element are included in the game environment element capable of controlling the ability value of the registered item which is applied in the game play, and the user uses an item having a different ability value according to the game environment element.

When the server receives a selection-input for the quick start menu item from the user terminal, the server determines whether at least one omission condition that is a condition under which some operations among the predetermined operations may be omitted, is satisfied (S12).

In the cases where the physical strength element, which is the element consumed during the game play, and decreasing an applied ability value according to the consumption, is equal to or greater than a predetermined numerical value, a use period of a character is equal to or greater than a predetermined period, and the character is applied to the game play to be in a usable state, the server determines that the omission condition is satisfied, and when any one of the aforementioned cases is not satisfied, the server determines that the omission condition is not satisfied.

When the server determines that at least one omission condition that is the condition under which some operations among the predetermined operations may be omitted is satisfied, the server controls the game play to be started (S13).

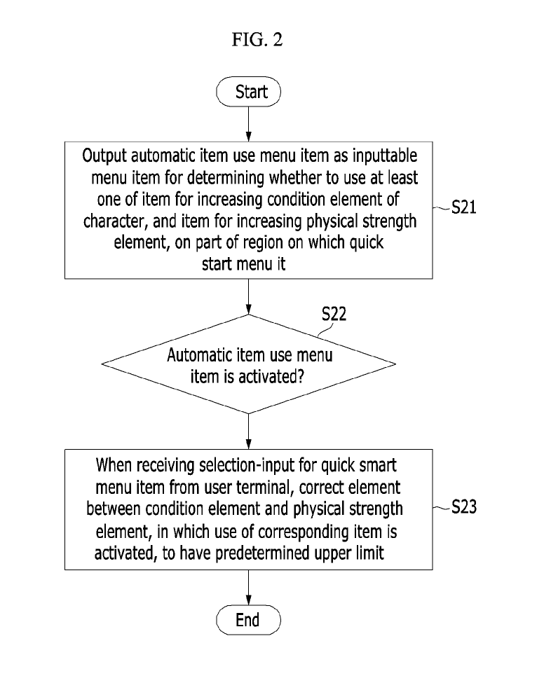

FIG. 2 is a flowchart illustrating a method of using an automatic item use menu item according to an exemplary embodiment of the present invention.

Referring to FIG. 2, the automatic item use menu item is a menu item output on a part of the region on which the quick start menu item is displayed during the transmission of the quick start menu item disclosed in FIG. 1. Accordingly, the method of FIG. 2 may be performed with a linkage to the performance of operation S11 of FIG. 1.

The server outputs the automatic item use menu item as an inputtable menu item for determining whether to use at least one of an item for increasing the condition element which is an element for changing an ability value of a character according to a predetermined ratio and applying the changed ability value during the game play, and an item for increasing the physical strength element which is an element consumed during the game play and decreasing an applied ability value according to the consumption, on the part of the region on which the quick start menu item is displayed (S21).

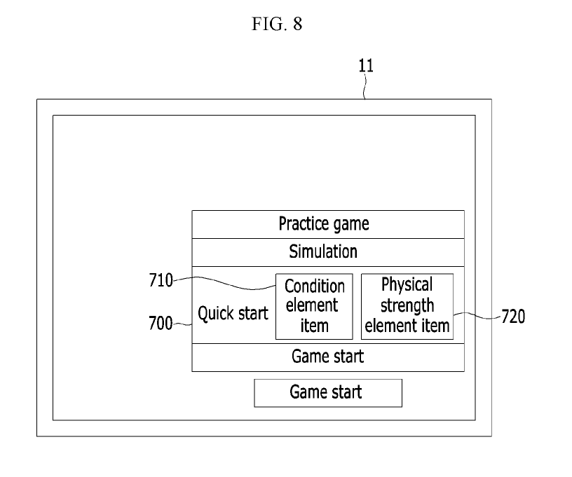

FIG. 8 illustrates that the automatic item use menu item including a condition element item 710 and a physical strength element item 720 is included in the part of the region on which the quick start menu item 700 is displayed.

Then, the server receives a user input, and determines whether the automatic item use menu item is activated (S22).

As a result of the determination, when the automatic item use menu item is activated, the server receives a selection input for the quick start menu item from the user terminal, and corrects the element between the condition element and the physical strength element, in which the use of the corresponding item is activated, to have a predetermined upper limit (S23).

Here, the correctable upper limits of the condition element item 710 and the physical strength element item 720 are predetermined. For example, even though a specific item is enhanced and corrected, when a level of the item reaches 10, which is the highest level, the item cannot be enhanced and corrected any more.

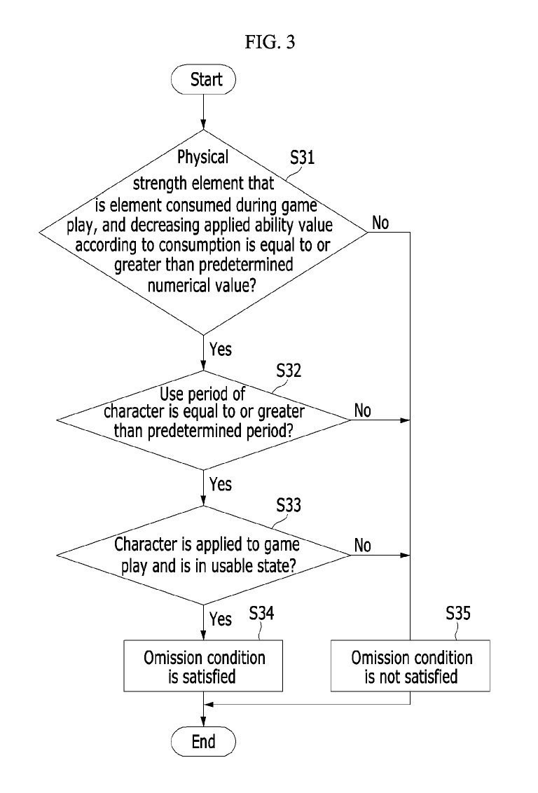

FIG. 3 is a flowchart illustrating a method of determining whether the omission condition is satisfied according to an exemplary embodiment of the present invention.

Referring to FIG. 3, the determination of whether the omission condition is satisfied may be performed in connection after the reception of the input of the quick start menu item from the user terminal as disclosed in FIG. 1. Further, the determination of whether the omission condition is satisfied may be performed after the automatic item use menu item is activated, and the element between the condition element and the physical strength element, in which the use of the corresponding item is activated, is corrected to have the predetermined upper limit as disclosed in FIG. 2.

In order to determine whether the omission condition is satisfied, the server determines whether the physical strength element that is the element consumed during the game play and decreasing an applied ability value according to the consumption, is equal to or greater than a predetermined numerical value (S31).

In the present invention, the physical strength element is an element consumed according to the game play, and when the physical strength element is consumed, an applied ability value is decreased. Accordingly, when the physical strength element is equal to or lower than the predetermined numerical value, it is impossible to perform a normal game play, so that the server determines whether the physical strength element is equal to or greater than the predetermined numerical value.

As a result of the determination, when the physical strength element is equal to or greater than the predetermined numerical value, the server determines whether a use period of the character is equal to or greater than a predetermined period (S32).

The number of use times of a character is predetermined in the game. For example, in a sport game, a player character referring to the item may be used only for a predetermined number of times of the event. When the user registers to a predetermined slot, whenever the game play is completed, that is, one event is terminated, the number of events capable of using the player character may be decreased. When an item is first obtained, the number of use times of the player character is set to, for example, 30 events and the like. As described above, when the number of use times of the player character is terminated to be 0, the number of use times may be increased to, for example, 30 events through extension of the use period again. As described above, when the number of use times of the character is terminated, the corresponding character cannot participate in the game any longer, so that the server needs to determine whether the use period of the character is left by the predetermined period or more.

As a result of the determination, when the physical strength element is equal to or greater than the predetermined numerical value, and the use period of the character is equal to or greater than the predetermined period, the server applies the character to the game play and determines whether the character is in a usable state (S33).

For example, in a sport game, when a player character gets injured, or violates a predetermined rule to receive a warning by the predetermined number of times or more, the player character cannot participate in the game, so that the character is in an unusable state. When the character is in the unusable state, the corresponding character cannot participate in the game, so that the server needs to determine whether the character is in the usable state.

As a result of the determination, when the physical strength element is equal to or greater than the predetermined numerical value, the use period of the character is equal to or greater than the predetermined period, and the character is applied to the game play and is in the usable state, the server determines that the omission condition is satisfied (S34), and controls the start of the game play.

However, as the result of the determination, when only any one omission condition is satisfied, that is, only the physical strength element is equal to or lower than the predetermined numerical value, only the use period of the character is equal to or lower than the predetermined period, or only the character is applied to the game play and is in the unusable state, the server determines that the omission condition is not satisfied (S35).

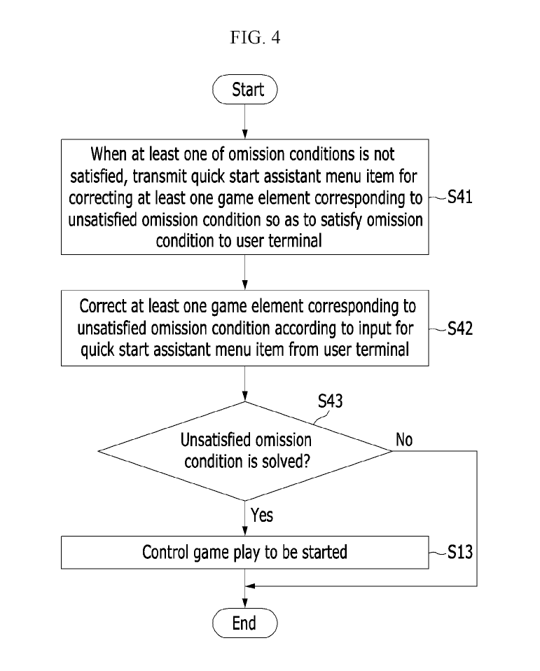

FIG. 4 is a flowchart illustrating a method of using a quick start assistant menu item according to an exemplary embodiment of the present invention.

Referring to FIG. 4, the quick start assistant menu item is a menu item for correcting an unsatisfied element when the omission condition illustrated in FIG. 3 is not satisfied, and may be transmitted to the user terminal.

When at least one of the omission conditions is not satisfied, the server transmits the quick start assistant menu item for correcting at least one game element corresponding to the unsatisfied omission condition so as to satisfy the omission condition to the user terminal (S41).

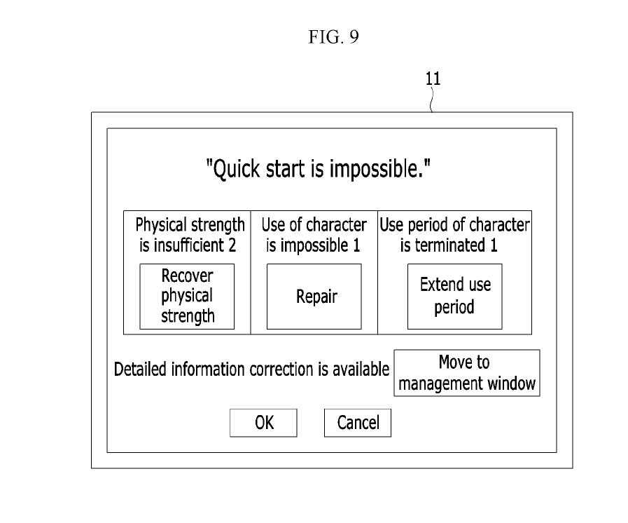

FIG. 9 illustrates the quick start assistant menu item transmitted to the user terminal by the server. The quick start assistant menu item illustrated in FIG. 9 suggests correction of the unsatisfied game element because of the impossibility of the quick start. It is illustrated in FIG. 9 that two physical strength insufficient elements exist, one character use unavailable element exists, and one character use period termination element exists, so that the quick start is impossible.

When the quick start assistant menu item is transmitted to the user terminal, the server corrects at least one game element corresponding to the unsatisfied omission condition according to the input for the quick start assistant menu item from the user terminal (S42).

Referring to FIG. 9, the server recovers physical strength of the physical strength insufficient element according to a physical strength recovery input from the user terminal, repairs the character to be in a usable state according to a character repair input from the user terminal, and extends a use period of the character according to a character use period extension input from the user terminal.

Here, when an item database of the user may include an item for correcting the game element, or a game point, the game element may be corrected. For example, referring to FIG. 9, a physical strength recovery item or a game point corresponding to the physical strength recovery item needs to exist in order to recover physical strength, a character repair item or a game point corresponding to the character repair item needs to exist in order to repair the character, and a character use period extension item or a game point corresponding to the character use period extension item needs to exist in order to extend a character use period. When the item or the game point for correcting the game element does not exist or is insufficient, the user may buy a corresponding item at an item shop, and buy a game point.

Then, the server determines whether the unsatisfied omission condition is solved through the correction of the game element (S43).

When the all of the unsatisfied omission conditions are solved, the server controls the start of the game play (S44).

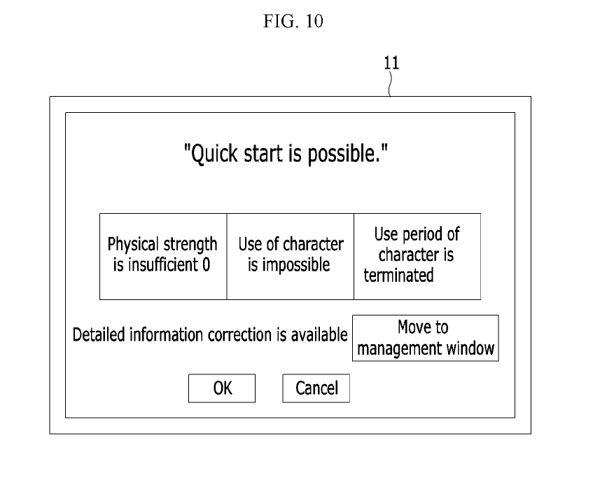

When the physical strength is recovered, the character is repaired, and the character use period is extended in FIG. 9, a message indicating that the quick start is available is output as illustrated in FIG. 10, and when a confirmation input is received through the screen of FIG. 10, the server controls the start of the game play.

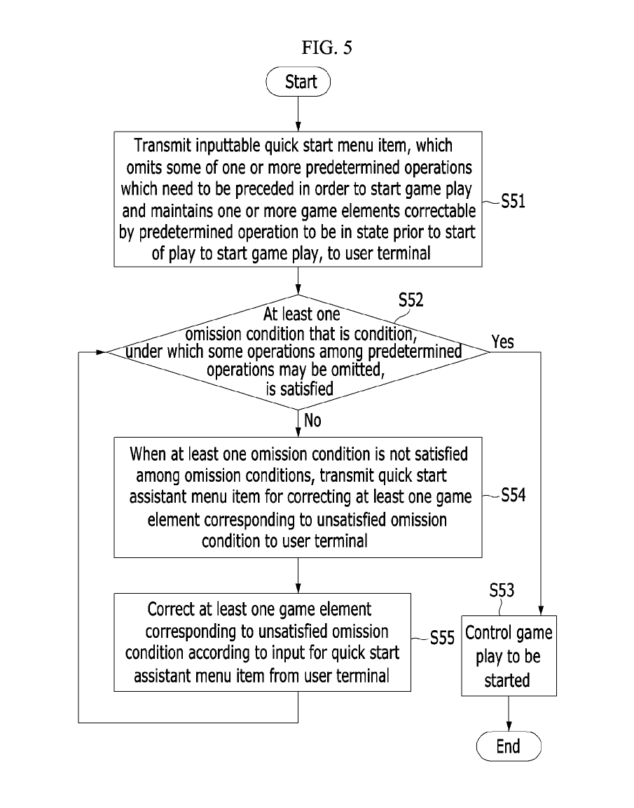

FIG. 5 is a flowchart illustrating a method of executing an online game according to another exemplary embodiment of the present invention. In description below, description of parts overlapping the description of FIGS. 1 to 4 will be omitted.

Referring to FIG. 5, in a method of executing an online game according to another exemplary embodiment of the present invention, a server for executing a game transmits an inputtable quick start menu item, which omits some of one or more predetermined operations which need to be preceded in order to start game play, and maintains one or more game elements correctable by the predetermined operations to be in a state prior to the start of the play to start the game play, to a user terminal (S51).

When the server receives a quick start input from the user terminal, the server determines whether at least one omission condition that is a condition under which some operations among the predetermined operations may be omitted, is satisfied (S52).

In the cases where the physical strength element, which is the element consumed during the game play and decreasing an applied ability value according to the consumption is equal to or greater than a predetermined numerical value, a use period of a character is equal to or greater than a predetermined period, and the character is applied to the game play to be in a usable state, the server determines that the omission condition is satisfied, and when any one of the aforementioned cases is not satisfied, the server determines that the omission condition is not satisfied.

When the server determines that at least one omission condition that is the condition under which some operations among the predetermined operations may be omitted is satisfied, the server controls the game play to be started (S53).

However, when the server determines that at least one omission condition that is the condition under which some operations among the predetermined operations may be omitted is not satisfied, that is, at least one omission condition exists, the server transmits a quick start assistant menu item for correcting at least one game element corresponding to the unsatisfied omission condition so as to satisfy the omission condition to the user terminal (S54).

When the quick start assistant menu item is transmitted to the user terminal, the server corrects at least one game element corresponding to the unsatisfied omission condition according to the input for the quick start assistant menu item from the user terminal (55).

Then, the server feeds back to operation S52 and determines whether the omission condition is satisfied, and when the omission condition is satisfied, the server controls the game play to be started.

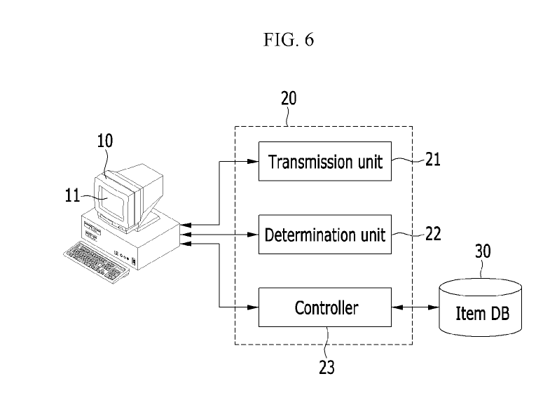

FIG. 6 is a block diagram illustrating a configuration of a server for executing an online game according to an exemplary embodiment of the present invention. In description below, description of parts overlapping the description of FIGS. 1 to 5 will be omitted.

Referring to FIG. 6, a server 20 for executing an online game according to an exemplary embodiment of the present invention includes a transmission unit 21, a determination unit 22, and a controller 23.

The user may access the game server 20 through a user terminal 10 and enjoy a game, and in this case, user information (particularly, information on items possessed by the user), information on items, and the like are stored in the item database 30.

The transmission unit 21 transmits an inputtable quick start menu item, which omits some of one or more predetermined operations which need to be preceded in order to start game play, and maintains one or more game elements correctable by the predetermined operations to be in a state prior to the start of the play to start the game play, to a user terminal.

When the determination unit 22 receives a selection input for the quick start menu item from the user terminal 10, the determination unit 22 determines whether at least one omission condition that is a condition under which some operations among the predetermined operations may be omitted, is satisfied.

As a result of the determination by the determination unit 22, when all of the omission conditions are satisfied, the controller 23 controls the game play to be started.

In this case, when the physical strength element, which is the element consumed during the game play and decreasing an applied ability value according to the consumption is equal to or greater than a predetermined numerical value, a use period of a character is equal to or greater than a predetermined period, and the character is applied to the game play to be in a usable state, the determination unit 22 determines that the omission condition is satisfied.

The transmission unit 21 outputs the automatic item use menu item as an inputtable menu item for determining whether to use at least one of an item for increasing the condition element which is an element for changing an ability value of a character according to a predetermined ratio and applying the changed ability value during the game play, and an item for increasing the physical strength element which is an element consumed during the game play and decreasing the applied ability value according to the consumption, on the part of the region on which the quick start menu item is displayed. When the automatic item use menu item is activated, the transmission unit 21 corrects the element between the condition element and the physical strength element, in which the use of the corresponding item is activated, to have a predetermined upper limit.

Further, in the case where the use of the item corresponding to the physical strength element is activated in the automatic item use menu item, the use period of the character is equal to or greater than the predetermined period, and the character is applied to the game play and is in the usable state, the determination unit 22 determines that the omission condition is satisfied, and makes the controller 23 play the game.

When it is determined that at least one omission condition exists, the transmission unit 21 transmits the quick start assistant menu item for correcting at least one game element corresponding to the unsatisfied omission condition so as to satisfy the omission condition to the user terminal 10.

When it is determined that at least one game element corresponding to the unsatisfied omission condition is corrected according to the input from the user terminal 10 for the quick start assistant menu item and the unsatisfied omission condition is solved, the controller 23 controls the game play to be started.

The aforementioned method of executing the online game according to the exemplary embodiment of the present invention may be executed by an application (which may include a program included in a platform, an operating system, and the like basically mounted in the terminal) basically installed in the terminal, and an application (that is, a program) which the user directly installs in the terminal through an application store server, and an application provider server, such as a web server, related to an application or a corresponding service. In view of this, the aforementioned method of executing the online game according to the exemplary embodiment of the present invention may be implemented as an application (that is, a program) basically installed in the terminal or directly installed by the user, and recorded in a computer-readable recording medium, such as a terminal.

The program is recorded in the computer readable recording medium and executed by a computer, so that the aforementioned functions may be executed.

As described above, in order to execute the method of executing the online game according to each exemplary embodiment of the present invention, the aforementioned program may include a code which is coded with a computer language, such as C, C++, JAVA, and a machine language, readable by a processor (CPU) of a computer.

The code may include a function code related to functions defining the aforementioned functions, and may also include an execution procedure-related control code necessary for executing the aforementioned functions by a processor of a computer according to a predetermined procedure.

Further, the code may include additional information necessary for executing the aforementioned function by a processor of a computer, or a memory reference related code for a location (address) of an internal or external memory of a computer at which the media is referred to.

Additionally, in the case where the processor of the computer needs to communicate with another remote computer or server in order to execute the aforementioned functions, the code may further include a communication-related code regarding how to communicate, by the processor of the computer, with another remote computer or server by using a communication module (for example, a wired and/or wireless communication module) of the computer, and for the kind of information or media which needs to be transceived during communication.

Further, a functional program for implementing the present invention, a code and code segment related to the functional program, and the like may be easily inferred or changed by programmers in the art to which the present invention pertains considering a system environment of the computer reading a recording medium and executing the program.

Examples of the aforementioned recording medium recording the program and readable by the computer include a ROM, a RAM, a CD-ROM, a magnetic tape, a floppy disk, and an optical media storage device.

Further, the aforementioned recording medium recording the program and readable by the computer is distributed to computer systems connected through a network, and a computer readable code may be stored and executed by a distribution scheme. In this case, at least one computer among the plurality of distributed computers may execute a part of the suggested functions and transmit a result of the execution to at least one of other distributed computers, and the computer receiving the result may also execute a part of the suggested functions and provide the result to other distributed computers.

Particularly, the computer readable recording medium storing the application that is the program for executing the method of executing the online game according to each exemplary embodiment of the present invention may be a storage medium (for example, a hard disk) included in an application store server, and an application provider server of a web server and the like related to an application or a corresponding service, or an application provider server itself.

The computer capable of reading the recording medium storing the application that is the program for executing the method of executing the online game according to the exemplary embodiment of the present invention may include a mobile terminal, such as a smart phone, a tablet PC, a personal digital assistant (PDA), and a mobile communication terminal, as well as a general PC, such as a general desktop computer or notebook computer, and in addition, may be interpreted as all of the devices capable of performing computing.

Further, when the computer capable of reading the recording medium storing the application that is the program for executing the method of executing the online game according to each exemplary embodiment of the present invention is a mobile terminal, such as a smart phone, a tablet PC, a personal digital assistant (PDA), and a mobile communication terminal, the application may be downloaded from the application provider server to a general PC and installed in a mobile terminal through a synchronization program.

In the above description, although it is described that all of the constituent elements configuring the exemplary embodiment of the present invention are combined into one element, or are combined and operated, the present invention is not essentially limited to the exemplary embodiment. That is, within the scope of the object of the present invention, all of the constituent elements may be selectively combined into at least one unit to be operated. Further, each of the constituent elements may be implemented as one independent piece of hardware, but some or the entirety of the constituent elements are selectively combined to be implemented as a computer program including a program module performing some or the entirety of the functions combined by one or a plurality of pieces of hardware. Codes and code segments configuring the computer program may be easily inferred by those skilled in the art. The computer program is stored in a computer readable media, and read and executed by the computer to implement the exemplary embodiment of the present invention. The storage media of the computer program may include a magnetic recording medium, an optical recording medium, and the like.

In addition, since terms, such as “including,” “comprising,” and “having” mean that one or more corresponding components may exist unless it is specifically described to the contrary, and it shall be construed that one or more other components may be included and not be excluded. If they are not contrarily defined, all terms used herein including technological or scientific terms have the same meaning as those generally understood by a person with ordinary skill in the art. A term ordinarily used like that defined by a dictionary shall be construed that it has a meaning equal to that in the context of a related description, and shall not be construed as an ideal or excessively formal meaning unless it is clearly defined in the present specification.

Although the exemplary embodiments of the present invention have been described for the purpose of illustrating the technical spirit of the present invention, those skilled in the art will appreciate that various corrections and modifications are possible, without departing from the essential characteristic of the invention. Therefore, the exemplary embodiments disclosed in the present invention are not intended to limit but to illustrate the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of executing an online game, comprising:
transmitting, by a server for executing the online game, an inputtable quick start menu item, which omits some of one or more predetermined operations which need to be preceded in order to start game play, and maintains one or more game elements correctable by the predetermined operations to be in a state prior to the start of the play to start the game play, to a user terminal;
determining whether at least one omission condition that is a condition under which some operations among the predetermined operations are omitted, is satisfied when receiving a selection-input for the quick start menu item from the user terminal; and
controlling the game play to be started when all of the omission conditions are satisfied.

2. The method of claim 1, wherein
the one or more predetermined operations which need to be preceded include
replacing one or more characters played in the game or changing states of the one or more characters as an operation of setting the one or more game elements.

3. The method of claim 2, wherein
the state of the character
is at least one of a state of a condition element which is an element for changing an applied ability value according to a predetermined ratio and applying the changed ability value, and a state of a physical strength element which is an element consumed during the game play and decreasing the applied ability value according to the consumption, when being used during the game play.

4. The method of claim 1, wherein
the determining whether the omission condition is satisfied includes
determining that the omission condition is satisfied when a physical strength element which is an element consumed during the game play and decreasing the applied ability value according to the consumption is equal to or greater than a predetermined numerical value, a use period of the character is equal to or greater than a predetermined period, and the character is applied to the game play and is in a usable state.

5. The method of claim 1, wherein
the transmitting of the quick start menu item includes
outputting an automatic item use menu item as an inputtable menu item for determining whether to use at least one of an item for increasing a condition element which is an element for changing an ability value of the character according to a predetermined ratio and applying the changed ability value during the game play, and an item for increasing a physical strength element which is an element consumed during the game play and decreasing the applied ability value according to the consumption, on a part of the region on which the quick start menu item is displayed.

6. The method of claim 5, further comprising,
when the automatic item use menu item is activated, correcting an element between the condition element and the physical strength element, in which a use of a corresponding item is activated, to have a predetermined upper limit when the quick start menu item is selected and input by the user terminal.

7. The method of claim 5, wherein
the determining whether the omission condition is satisfied includes,
determining that the omission condition is satisfied when a use period of the character is equal to or greater than a predetermined period, and the character is applied to the game play and is in a usable state.

8. The method of claim 1, further comprising,
after the determining whether the omission condition is satisfied,
when it is determined that there are one or more unsatisfied omission conditions among the omission conditions, transmitting a quick start assistant menu item for correcting one or more game elements corresponding to the unsatisfied omission conditions to the user terminal.

9. The method of claim 8, wherein
the controlling of the game play to be started includes,
according to an input from the user terminal for the quick start assistant menu item, when it is determined that one or more game elements corresponding to the unsatisfied omission conditions are corrected so that all of the unsatisfied omission conditions are solved, controlling the game play to be started.

10. A server for executing an online game, comprising:
a transmission unit configured to transmit an inputtable quick start menu item, which omits some of one or more predetermined operations which need to be preceded in order to start game play, and maintains one or more game elements correctable by the predetermined operations to be in a state prior to the start of the play to start the game play, to a user terminal;
a determination unit configured to determine whether at least one omission condition that is a condition under which some operations among the predetermined operations are omitted, is satisfied when receiving a selection-input for the quick start menu item from the user terminal; and
a controller configured to control the game play to be started when all of the omission conditions are satisfied as a result of the determination of the determination unit.

11. The server of claim 10, wherein
the determination unit
determines that the omission condition is satisfied when a physical strength element which is an element consumed during the game play and decreasing the applied ability value according to the consumption is equal to or greater than a predetermined numerical value, the use period of the character is equal to or greater than a predetermined period, and the character is applied to the game play and is in a usable state.

12. The server of claim 10, wherein
the determination unit
determines that, in the case where a use of an item corresponding to the physical strength element is activated in the automatic item use menu item, the omission condition is satisfied when a use period of the character is equal to or greater than a predetermined period, and the character is applied to the game play and is in a usable state.

13. The server of claim 10, wherein
when it is determined that there are one or more unsatisfied omission conditions among the omission conditions, the transmission unit transmits a quick start assistant menu item for correcting one or more game elements corresponding to the unsatisfied omission conditions to the user terminal.

14. The server of claim 13, wherein
according to an input from the user terminal for the quick start assistant menu item, when it is determined that one or more game elements corresponding to the unsatisfied omission conditions are corrected so that all of the unsatisfied omission conditions are solved, the controller controls the game play to be started.

15. A computer readable recording medium recording a program for implementing a method of executing an online game, the method comprising:
transmitting, by a server for executing the online game, an inputtable quick start menu item, which omits some of one or more predetermined operations which need to be preceded in order to start game play, and maintains one or more game elements correctable by the predetermined operations to be in a state prior to the start of the play to start the game play, to a user terminal;
determining whether at least one omission condition that is a condition under which some operations among the predetermined operations are omitted, is satisfied when receiving a selection-input for the quick start menu item from the user terminal; and
controlling the game play to be started when all of the omission conditions are satisfied.
